(19) United States
(12) Patent Application Publication
(10) Pub. No.: US 2014/0113077 A1
(43) Pub. Date: Apr. 24, 2014

(54) MANUFACTURING METHOD OF A COMPOSITE CLOTH

(71) Applicant: KAI-HSI TSENG, XIANXI TOWNSHIP (TW)

(72) Inventor: KAI-HSI TSENG, XIANXI TOWNSHIP (TW)

(21) Appl. No.: 13/658,727

(22) Filed: Oct. 23, 2012

(51) Int. Cl. B05D 1/38; C23C 28/00

(52) U.S. Cl. 427/294; 205/183; 427/419.1

(57) ABSTRACT

A manufacturing method of a composite cloth has steps of: preparing a work-in-process composite cloth, surface treating the work-in-process composite cloth, and coating the work-in-process composite cloth with a non-shielding metallized layer. In the step of preparing a work-in-process composite cloth, a work-in-process composite cloth allowing electromagnetic waves to pass through is prepared. In the step of surface treating the work-in-process composite cloth, a surface of the work-in-process composite cloth is coupling-processed, and then is dried. In the step of coating the work-in-process composite cloth with a non-shielding metallized layer, the surface of the work-in-process composite cloth is coated with a non-shielding metallized layer whose thickness ranges from 10 Å (angstrom) to 100 Å (angstrom). Accordingly, a boring step and a patching step are spared.

### BACKGROUND OF THE INVENTION

1. Field of the Invention

The present invention relates to a manufacturing method of a composite cloth, and more particularly to a manufacturing method of a composite cloth that can spare a boring step and a patching step.

2. Description of Related Art

Carbon fibers have been widely applied to a housing of an electronic device, such as a mobile phone. Accordingly, the housing becomes thin and light, has high strength, and attracts consumers to purchase the electronic device.

Carbon fibers are weaved to form a conventional composite cloth, and then the composite cloth is immersed in resin. Consequently, the composite cloth is cut to form the housing. Because the housing is made of conductive carbon fibers and will interfere with electromagnetic waves emitted from a communication device, such as an antenna, of the electronic device, the housing needs to be bored. Accordingly, the electromagnetic waves can pass through the housing via a bore of the housing.

However, a rim of the bore needs to be coated with plastic or glass fiber for patching and enhancing structural strength. Paint is then coated on the plastic or glass fiber such that a chromatic aberration between the housing and the plastic or glass fiber can be reduced.

Nevertheless, the step of boring and the step of patching are time-consuming The painting procedure is also inconvenient and troublesome, and cannot completely eliminate the chromatic aberration. Furthermore, the bore reduces aesthetic appeal of the housing.

To overcome the shortcomings, the present invention tends to provide a manufacturing method of a composite cloth to mitigate the aforementioned problems.

### SUMMARY OF THE INVENTION

The main objective of the invention is to provide a manufacturing method of a composite cloth that can spare a boring step and a patching step.

A manufacturing method of a composite cloth has steps of: preparing a work-in-process composite cloth, surface treating the work-in-process composite cloth, and coating the work-in-process composite cloth with a non-shielding metallized layer. In the step of preparing a work-in-process composite cloth, a work-in-process composite cloth allowing electromagnetic waves to pass through is prepared. In the step of surface treating the work-in-process composite cloth, a surface of the work-in-process composite cloth is coupling-processed, and then is dried. In the step of coating the work-in-process composite cloth with a non-shielding metallized layer, the surface of the work-in-process composite cloth is coated with a non-shielding metallized layer whose thickness ranges from 10 Å (angstrom) to 100 Å (angstrom). Accordingly, a boring step and a patching step are spared.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a manufacturing method of a composite cloth in accordance with the present invention;

FIG. 2 is a perspective view of the work-in-process composite cloth manufactured by the manufacturing method in FIG. 1;

FIG. 3 is operational views of the manufacturing method showing the non-shielding metallized layer and the colored layer are sequentially coated on the work-in-process composite cloth;

FIG. 4 is a perspective view of the composite cloth in FIG. 2 after being coated with a colored layer;

FIG. 5 is a front perspective view of the housing cut from the composite cloth in FIG. 4; and

FIG. 6 is a rear perspective view of the housing cut from the composite cloth in FIG. 5.

### DETAILED DESCRIPTION OF PREFERRED EMBODIMENT

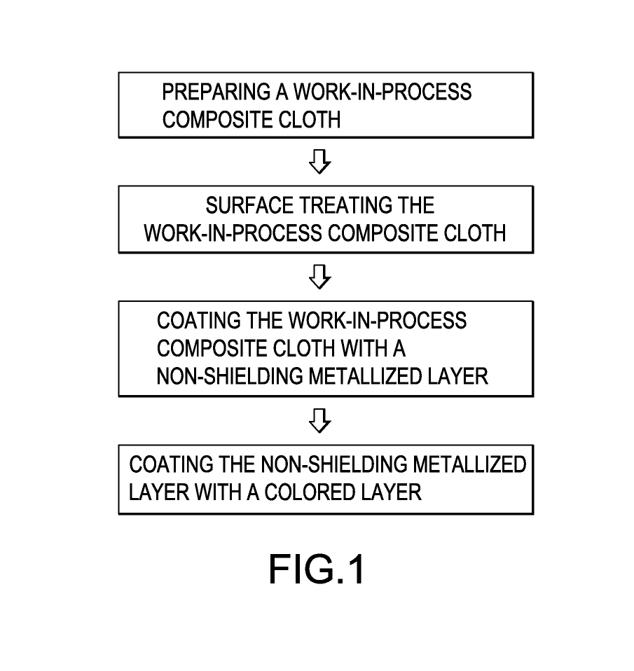

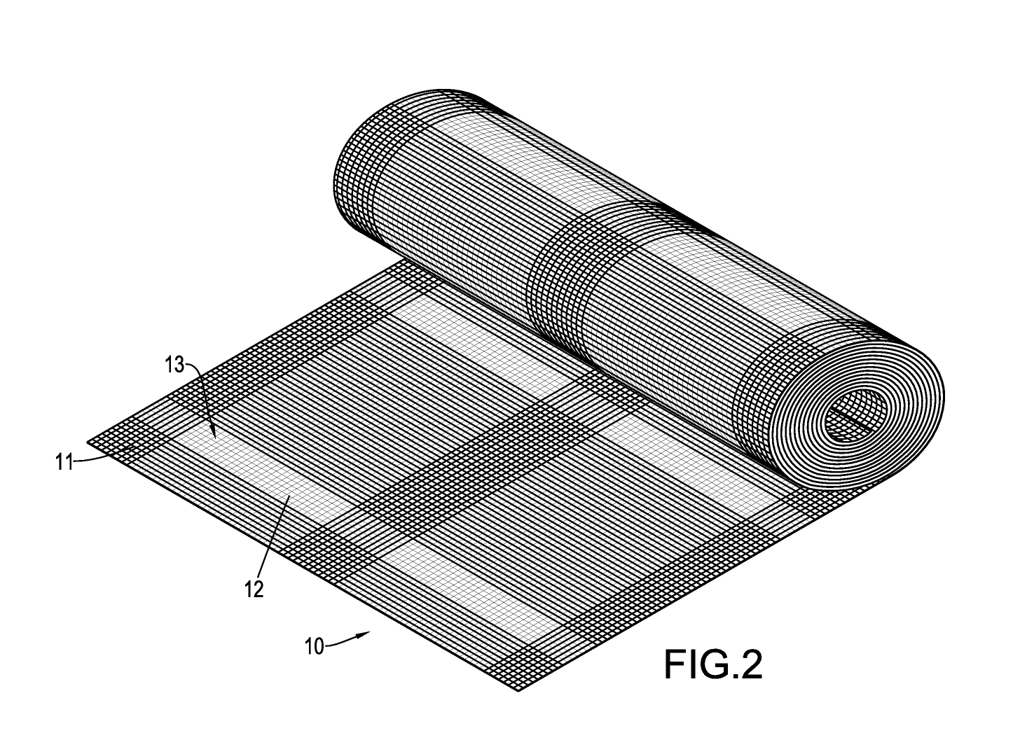

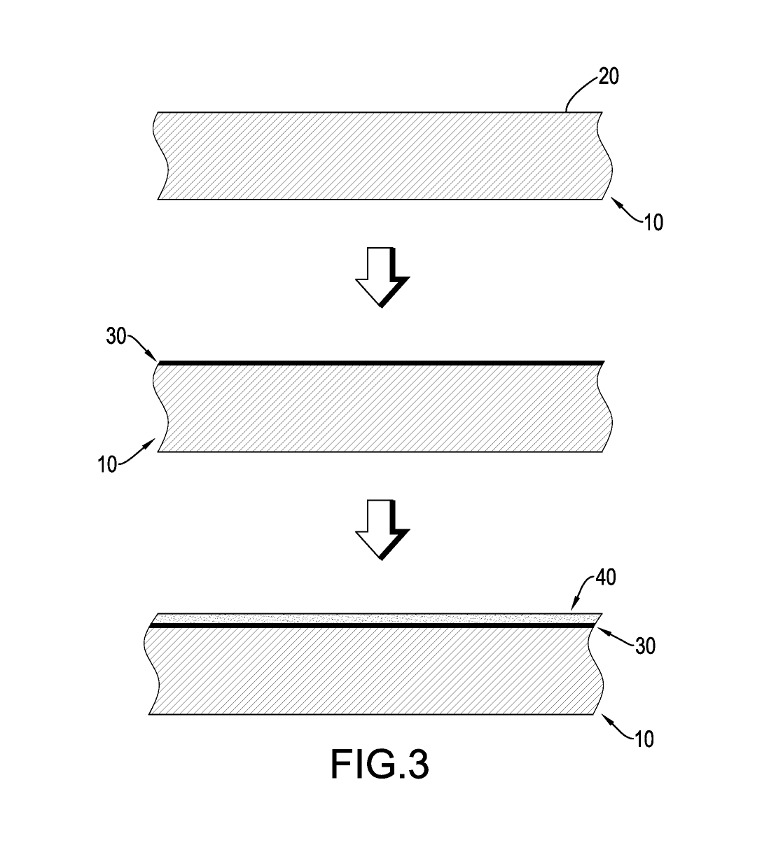

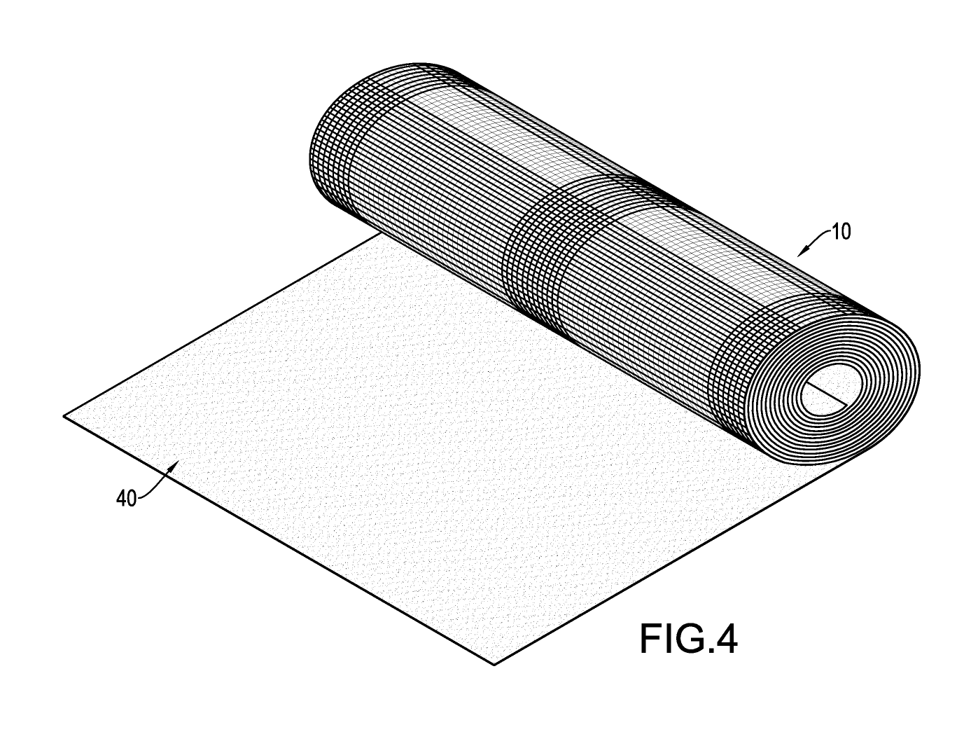

With reference to FIGS. 1 to 4, a manufacturing method of a composite cloth in accordance with the present invention comprises the following steps:

A. Preparing a work-in-process composite cloth:

A work-in-process composite cloth 10 allowing electromagnetic waves to pass through is prepared. Preferably, multiple conductive fibers 11 and multiple insulating fibers 12 are prepared. Each conductive fiber 11 may be carbon fiber or metallic fiber. Each insulating fiber 12 may be made of chemical or inorganic fiber having high strength and tenacity, such as PET (Polyethylene terephthalate), PE (Polyethylene), PP (Polypropylene), Kevlar, Aramid, Para Aramid, glass fiber, Basalt fiber, etc.

The conductive fibers 11 and the insulating fibers 12 are weaved to form the work-in-process composite cloth 10, and the work-in-process composite cloth 10 has at least one non-shielding area 13 composed of the insulating fibers 12. The at least one non-shielding area 13 can correspondingly align with at least one communication device of an electronic device such as a mobile phone. Accordingly, electromagnetic waves emitted from the at least one communication device can pass through the work-in-process composite cloth 10 via the at least one non-shielding area 13.

B. Surface treating the work-in-process composite cloth:

A surface of the work-in-process composite cloth 10 is coupling-processed, and then is dried.

C. Coating the work-in-process composite cloth with a non-shielding metallized layer:

The surface of the work-in-process composite cloth 10 is coated with a non-shielding metallized layer 30 whose thickness ranges from 10 Å (angstrom) to 100 Å (angstrom). Preferably, the non-shielding metallized layer 30 is a non conductive vacuum metallized film or a micro-electroplated metallized film.

Compared to a conventional metallized layer whose thickness usually ranges from 350 Å to 600 Å, the non-shielding metallized layer 30 of the present invention is thin enough such that cations and anions of the non-shielding metallized layer 30 are prevented from being arranged into a conductive pattern. Consequently, the non-shielding metallized layer 30 is not conductive and the electromagnetic waves can pass through the non-shielding metallized layer 30.

D. Coating the non-shielding metallized layer with a colored layer:

A colored layer 40 is coated on the non-shielding metallized layer 30 and is opposite to the work-in-process composite cloth 10.

The step of coating the non-shielding metallized layer with a colored layer may be optional. Accordingly, the non-shielding metallized layer 30 can still allow electromagnetic waves to pass through and also display metallic luster and color uniformity.

The work-in-process composite cloth 10 may be simply composed of the insulating fibers 12 without the conductive fibers 11. Accordingly, the work-in-process composite cloth 10 does not have the non-shielding area 13.

From the above description, it is noted that the present invention has the following advantages:

1. No boring step and patching step:

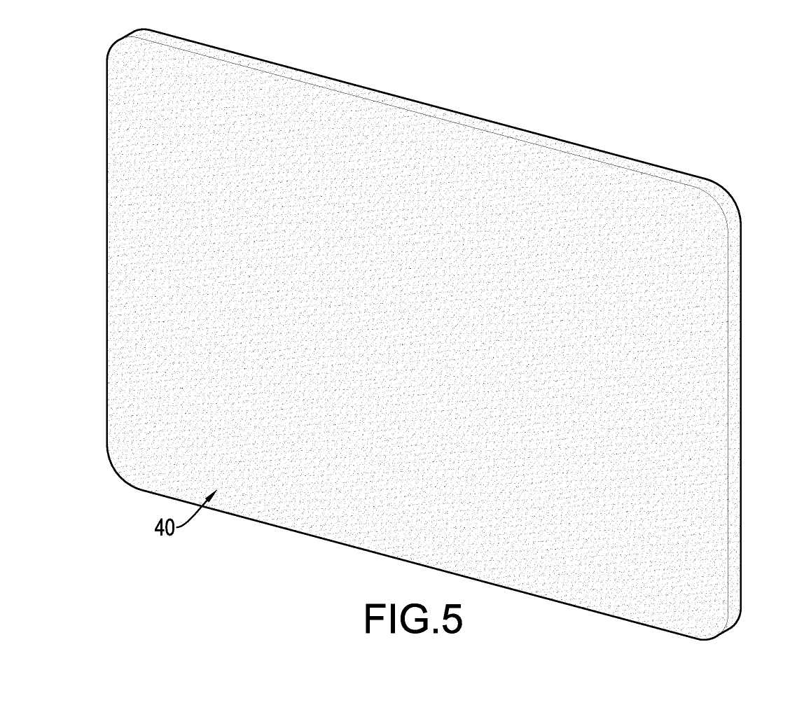

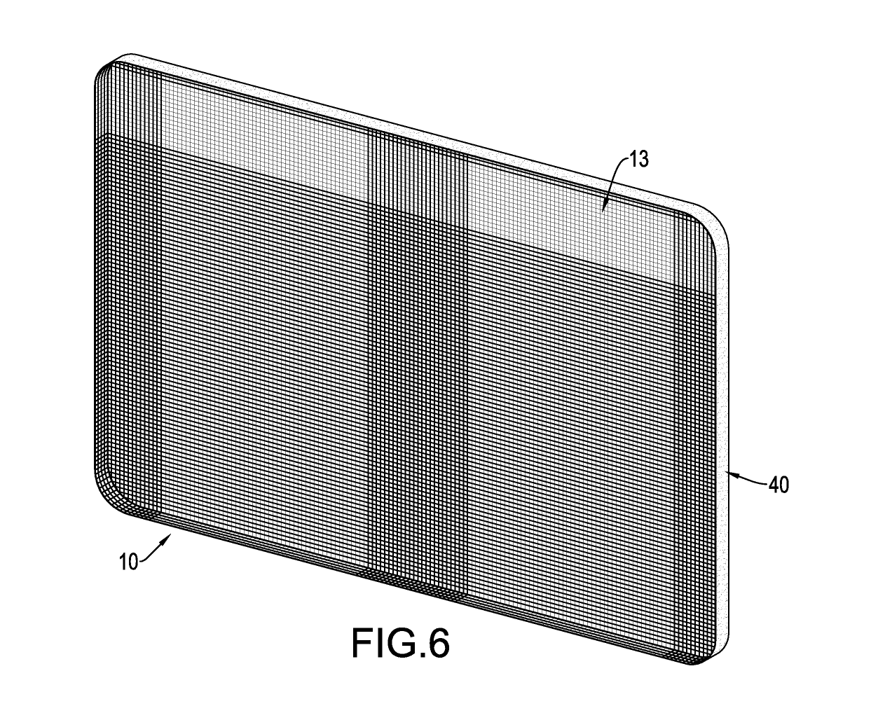

With reference to FIGS. 5 and 6, the composite cloth is immersed in resin and then is cut into a housing in a desired shape. With the non-shielding area 13, electromagnetic waves can pass through the housing via the non-shielding area 13. Accordingly, the housing does not have to be bored, and the boring and patching steps are spared.

2. Improved appearance:

The non-shielding metallized layer 30 is capable of allowing electromagnetic waves to pass through and also displaying metallic luster and color uniformity. The colored layer 40 can also make the appearance of the composite cloth 10 have color uniformity and avoid chromatic aberration. Accordingly, the appearance of the housing can attract consumers to purchase the electronic device.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method of a composite cloth comprising steps of:
preparing a work-in-process composite cloth, wherein a work-in-process composite cloth allowing electromagnetic waves to pass through is prepared;
surface treating the work-in-process composite cloth, wherein a surface of the work-in-process composite cloth is coupling-processed, and then is dried; and
coating the work-in-process composite cloth with a non-shielding metalized layer, wherein the surface of the work-in-process composite cloth is coated with a non-shielding metallized layer whose thickness ranges from 10 Å (angstrom) to 100 Å (angstrom).

2. The manufacturing method of a composite cloth as claimed in claim 1, wherein in the step of preparing a work-in-process composite cloth,
multiple conductive fibers and multiple insulating fibers are prepared; and
the conductive fibers and the insulating fibers are weaved to form the work-in-process composite cloth, and the work-in-process composite cloth has at least one non-shielding area composed of the insulating fibers.

3. The manufacturing method of a composite cloth as claimed in claim 1, wherein after the step of coating the work-in-process composite cloth with a non-shielding metallized layer,
a colored layer is coated on the non-shielding metallized layer and is opposite to the work-in-process composite cloth.

4. The manufacturing method of a composite cloth as claimed in claim 2, wherein after the step of coating the work-in-process composite cloth with a non-shielding metallized layer,
a colored layer is coated on the non-shielding metallized layer and is opposite to the work-in-process composite cloth.

5. The manufacturing method of a composite cloth as claimed in claim 3, wherein the non-shielding metallized layer is a non conductive vacuum metallized film.

6. The manufacturing method of a composite cloth as claimed in claim 4, wherein the non-shielding metallized layer is a non conductive vacuum metallized film.

7. The manufacturing method of a composite cloth as claimed in claim 3, wherein the non-shielding metallized layer is a micro-electroplated metallized film.

8. The manufacturing method of a composite cloth as claimed in claim 4, wherein the non-shielding metallized layer is a micro-electroplated metallized film.
